(19) United States
(12) Patent Application Publication
(10) Pub. No.: US 2026/0226245 A1
(43) Pub. Date: Aug. 6, 2026

(54) METHODS OF THERMOFORMING CELLULOSE ESTER FOAMED ARTICLES

(71) Applicant: Eastman Chemical Company, Kingsport, TN (US)

(72) Inventors: Michael Eugene Donelson, Kingsport, TN (US); Rahul Shankar, Kingsport, TN (US); Goliath Beniah, York, PA (US); Stephanie Kay Clendennen, Kingsport, TN (US); Gaurav Amarpuri, Alpharetta, GA (US); Nicola Anne Herndon, Bristol, TN (US); James Collins Maine, Church Hill, TN (US); Madeleine Kate Miller, Johnson City, TN (US)

(73) Assignee: Eastman Chemical Company, Kingsport, TN (US)

(21) Appl. No.: 19/159,706

(22) PCT Filed: Feb. 27, 2024
(86) PCT No.: PCT/US2024/017375

§ 371 Date: Aug. 26, 2025

Related U.S. Application Data
(60) Provisional application No. 63/487,030, filed on Feb. 27, 2023.

(51) Int. Cl. C08J 9/36; C08J 5/18; C08J 9/00

(52) U.S. Cl. CPC C08J 9/36; C08J 5/18; C08J 9/0061; C08J 2201/03; C08J 2203/06; C08J 2301/12

(57) ABSTRACT

Methods of thermoforming foamed cellulose ester sheets into foamed trays. The methods, and compositions used therein, provide for foamed trays having desirable skin integrity after thermoforming. One or more high heat capacity additives and/or melt strength enhancers may be used to provide improved skin integrity at higher thermoforming draw ratios.

### BACKGROUND OF THE INVENTION

Many foam articles, such as food-packaging articles, are single-use items that are intended to be disposed of after use. One commercially important material used to make foam articles is polystyrene. However, polystyrene is neither compostable nor biodegradable. Moreover, some municipalities, states, and countries have enacted, or are considering enacting, bans on the use polystyrene-based foams. Thus, it would be desirable to find alternative materials for use in foam articles, as well as viable compositions, methods, and systems for producing such articles.

During thermoforming of foamed articles, a flat foamed sheet is heated stretched into a mold. The deeper the mold, the more the sheet material must be stretched, which can be characterized by its draw ratio. However, if the draw ratio is too high, the sheet can tear or crack. Thus, it would be desirable to find acceptable draw ratios for articles formed from cellulose ester foamed sheets and to find compositions and processes for increasing the draw ratios while maintaining acceptable skin integrity of the foamed article product.

### SUMMARY OF THE INVENTION

In one embodiment or in combination with any other embodiment mentioned herein, there is provided a method of forming a foamed article. The method comprises: (a) producing a foamed sheet from a cellulose ester composition; and (b) thermoforming the foamed sheet in a mold having a footprint area (X) and a surface area that is less than 1.9X, thereby forming the foamed article.

In another embodiment or in combination with any other embodiment mentioned herein, there is provided a method of forming a foamed article. The method comprises: (a) producing a foamed sheet from a composition comprising cellulose ester and an additive having a specific heat capacity of at least 2000 J/(kg K); and (b) thermoforming the foamed sheet in a mold, thereby forming the foamed article.

In another embodiment or in combination with any other embodiment mentioned herein, there is provided a method of forming a foamed article. The method comprises: (a) producing a foamed sheet from a cellulose ester composition; and (b) thermoforming the foamed sheet in a mold having a footprint area (X) and a surface area that is at least 1.2X to 5.0X, thereby forming the foamed article.

### BRIEF DESCRIPTION OF THE DRAWINGS

FIG. 1 is a schematic diagram illustrating a biodegradable article forming process according to embodiments of the present invention;

FIG. 2 is a schematic diagram illustrating another biodegradable article forming process according to embodiments of the present invention;

FIG. 3 is a schematic diagram illustrating an extrusion section that may be used in the article forming processes of FIGS. 1 and/or 2, according to embodiments of the present invention;

FIG. 4 is a schematic diagram illustrating another extrusion section that may be used in the article forming process of FIGS. 1 and 2, according to embodiments of the present invention;

FIG. 5 is a schematic diagram illustrating a sheet forming section that may be used in the article forming processes of FIGS. 1 and/or 2, according to embodiments of the present invention;

### DETAILED DESCRIPTION

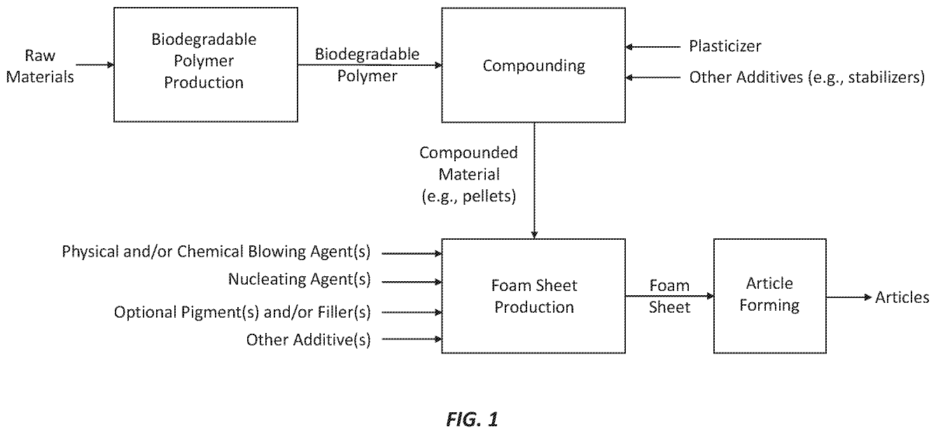

Embodiments are generally directed to methods, systems, and compositions for forming biodegradable particulate materials (e.g., pellets), foam sheets, and articles. Exemplary processes including the methods, systems, and compositions are depicted in FIGS. 1-5 and are described in greater detail below.

### Methods and Systems

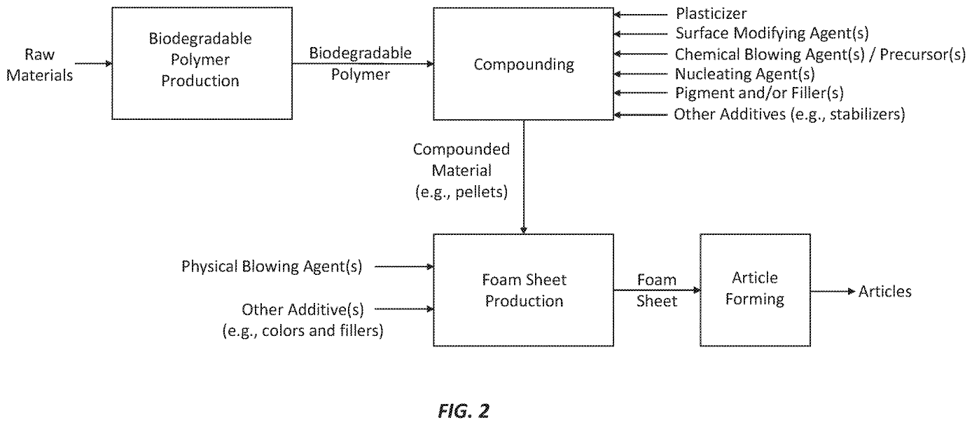

As shown in FIG. 1 and FIG. 2, raw materials may be introduced to a biodegradable polymer production process, which produces a biodegradable polymer material. In one embodiment or in combination with any other embodiment mentioned herein, the biodegradable polymer material comprises one or more cellulose esters. The one or more cellulose esters may comprise cellulose acetates. In such embodiments, the raw materials may comprise a pulp, such as wood pulp and/or cotton pulp. The pulp may be a dissolving-grade pulp and/or a paper-grade pulp. The cellulose in the pulp may esterified, for example with an acetic acid, to form the biodegradable cellulose ester polymer, such as a cellulose acetate polymer.

The biodegradable polymer material may then be introduced into a compounding process, in which the biodegradable polymer material may be mixed with plasticizer, and optionally one or more other additives (e.g., stabilizers), and formed into a compounded material comprising plasticized biodegradable polymer. Other additives may also be mixed with the polymer and plasticizer. For example, as shown in FIG. 2, the other materials (additives) may include, but are not limited to, stabilizers, physical blowing agent(s), chemical blowing agent(s) (and/or precursors), nucleating agent(s), surface modifying additive(s), pigment(s), filler(s), and/or other additive(s). Mixing can be accomplished by any known mixing technique, including, but not limited to, rolling in a cylindrical container, overhead stirring, sigma blade mixing, and tumbling.

The compounding process may include a particulating process. The particulating process may generally comprise mixing the biodegradable polymer material, plasticizer, and other additive(s) to form a mixed composition and forming particulate material from the composition. In particular, the particulating process may include a pelletization process, and the particulate material may comprise a quantity of pellets. The term “compounded CE material” means cellulose ester material formed during the compounding process, which may include a mixture of cellulose ester, plasticizer, and other additives. Further such compounded CE material may be in the form of particulate material or pellets. It should be understood that, as used herein, the phrases “particulating” or “particulating processes” may be the same as, or may at least include, “pelletizing” or “pelletizing processes.” In some embodiments, the particulating process may include pelletizing into a water bath, pelletizing on an air cooled belt, underwater pelletizing, solvent compounding, etc.

In one embodiment or in combination with any other embodiment mentioned herein, the plasticizer and other additive(s) may be mixed with cellulose esters by conventional melt compounding techniques, which involve combining the cellulose ester with plasticizer, and optionally the other additives, in a twin screw extruder with appropriate mixing elements and at appropriate temperatures and pressures to achieve a molten, homogeneously combined, cellulose ester mixture by the time the materials exit the extruder. The molten, compounded, cellulose ester mixture may then be extruded through a die with orifices that are about 2-6 mm in diameter so as to extrude a strand. This strand may then be cooled by water (e.g., via underwater pelletization) or air and cut at regular intervals to provide a uniform and desirable size and shape, referred to as “pellets” or “granules.” Although a process for forming pelletized compounded material is described herein, it will be understood that the compounded material fed to the foam sheet production process can be in any physical shape (e.g., pellets, powders, granules, fibers) in accordance with some embodiments. The term “compounded CE material” means cellulose ester material formed during the compounding process, which may include a mixture of cellulose ester, plasticizer, and other additives. Further such compounded CE material may be in the form of a molten mixture or a particulate material (e.g., pellets, powders, granules, fibers, etc.)

The compounded CE material, which as noted above may comprise pellets of plasticized biodegradable polymer, may then be introduced into a foam sheet production process, as illustrated in FIGS. 1 and 2. The foam sheet production process may include one or more zones/steps for producing a foam sheet or film, which are described in greater detail below. Although an exemplary foam sheet production process is described herein, it should be understood that certain aspects described herein may also be applicable to rigid (i.e., non-foamed) materials and articles. As shown in FIG. 1, in one embodiment or in combination with any other embodiment mentioned herein, various additives may be introduced to one or more zones of the foam sheet production process. The additives may include, but are not limited to, stabilizers, physical blowing agent(s), chemical blowing agent(s) (and/or precursors), nucleating agent(s), surface modifying additive(s), pigment(s), filler(s), and/or other additive(s).

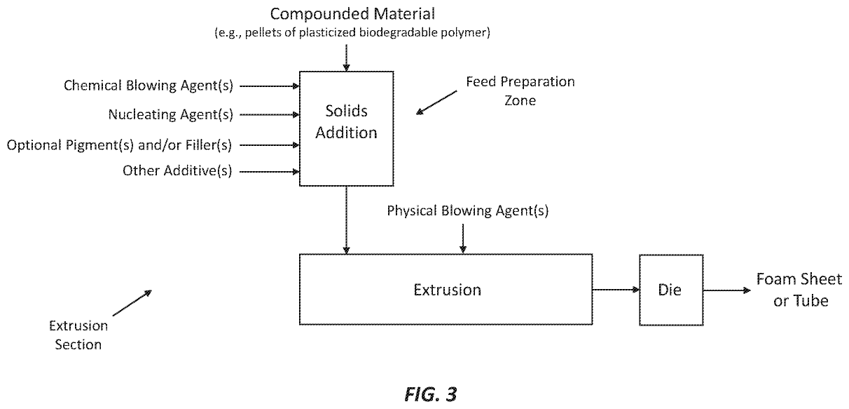

The foam sheet production process may generally include an extrusion section and a sheet forming section. An exemplary extrusion section is depicted in FIG. 3. As shown, the extrusion section may comprise a feed preparation zone, in which solid additives may be combined with the compounded CE material and introduced to the downstream extrusion zone. In one embodiment or in combination with any other embodiment mentioned herein, the feed preparation zone may comprise a feed hopper. Thus, the compounded CE material and the other solid additives may be deposited into the feed hopper, which directs the combined feed composition into the extrusion zone. The feed preparation zone may further comprise a mixer, in which the compounded CE material and one or more additive(s) may be mixed before being introduced to the hopper. Mixing can be accomplished by any known mixing technique, including, but not limited to, rolling in a cylindrical container, overhead stirring, sigma blade mixing, and tumbling. Exemplary solid additive(s) that can be combined with the compounded material may include chemical blowing agent(s), nucleating agent(s), surface modifying additive(s), pigment(s), filler(s), and/or other additive(s).

The combined feed composition from the feed preparation zone may then be introduction to the extrusion zone. The extrusion zone may generally comprise one or more extruders, which may include single screw and/or twin screw extruders. Within the extruder(s), the feed composition may be introduced into an extruder barrel and conveyed, via the screw(s), through a die, which forms an extrudate from the feed composition. The composition may be heated, and at least partially melted, as it is conveyed through the extruder barrel toward the die. Thus, the term “CE melt composition” is used herein to mean the cellulose ester-based feed composition that has been melted into a flowable, molten resin via the extrusion section. Heating may be supplied by external heaters positioned along the outside of the extruder barrel. The shape of the extrudate will generally depend on the shape and size of the die head. The extrudate may be further shaped by downstream processes, as described below.

One or more additive(s) may be introduced to the CE melt resin while in the extruder. For example, one or more physical blowing agent(s) may be added to the CE melt resin by injecting the physical blowing agent into the composition being conveyed within the extruder barrel.

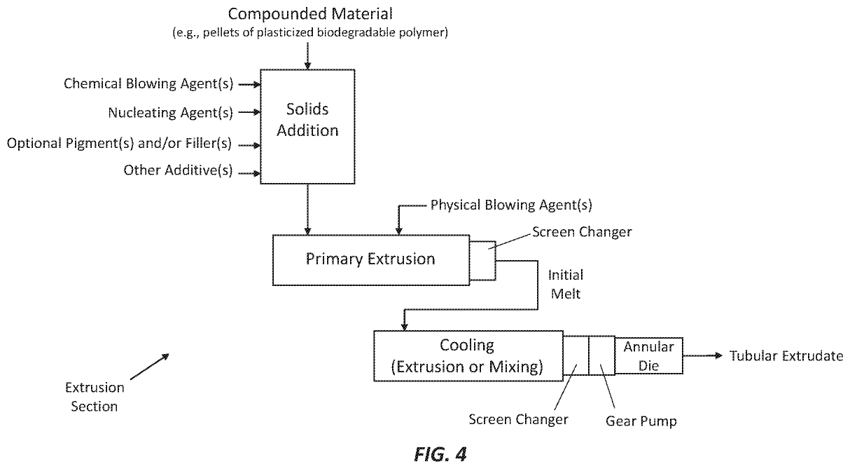

As depicted in FIG. 4, in one embodiment or in combination with any other embodiment mentioned herein, the extrusion zone may comprise a primary extrusion vessel and a cooling vessel. The primary extrusion vessel and cooling vessel may be separate devices or combined as a unitary apparatus. Regardless, the feed composition from the feed preparation zone is introduced into the primary extrusion vessel and at least partially melted as it is conveyed through the extruder barrel, as described above, to thereby produce the CE melt resin. The CE melt resin exiting the primary extrusion vessel may have a temperature from about 220° C. to about 240° C. One or more additives, such as blowing agent(s), may be added to the CE melt resin as it is conveyed through the primary extrusion vessel.

The CE melt resin from the primary extrusion vessel is then introduced into the cooling vessel. The cooling vessel may be a secondary extrusion vessel, which operates similarly to, but at a lower temperature than, the primary extrusion vessel. Within the cooling vessel, the CE melt resin may be further mixed to provide a substantially homogenous mixture of the melted polymer and other additive(s). The CE melt resin may then be directed through the die and out of the die head to provide a cellulose ester-based extrudate, which may be further processed in the sheet forming section of the foam sheet production process. In one embodiment or in combination with any other embodiment mentioned herein, the CE melt resin exiting the die head may have a temperature of at least 150° C., at least 160° C., at least 170° C., at least 180° C., at least 190° C., at least 200° C., from about 150° C. to about 220° C., and/or from about 170° C. to about 200° C.

As shown in FIG. 4, one or more filtration devices may be installed within the extrusion section to filter and remove particulate matter from the CE melt resin. For example, screen changer filtration devices may be installed at the downstream end of the primary and secondary extrusion vessels, which may remove solid components from the CE melt resin before directing the CE melt resin through the die head to the sheet forming section.

The sheet forming section may include any of a variety of systems and processes for shaping the extrudate into sheets of cellulose ester material that may be used in article formation. The shape of the extrudate will generally depend on the shape of the die head, while the shape of the sheets formed in the sheet forming section can depend on the shape of the die head and other downstream processes. For example, the extrudate may have a generally flat shape, or it may be annular and subjected to further processing to form a flat sheet. In embodiments in which the die has an annular shape, the die may have a diameter from 1 to 40 cm, from 2 to 20 cm, 2 to 10 cm, and/or 3 to 8 cm. Furthermore, the thickness of the opening from which extrudate is ejected, which is referred to herein as a “die gap,” may generally be sized from 0.1 to 6.0 mm, from 0.1 to 3.0 mm, and/or from 0.1 to 1.0 mm.

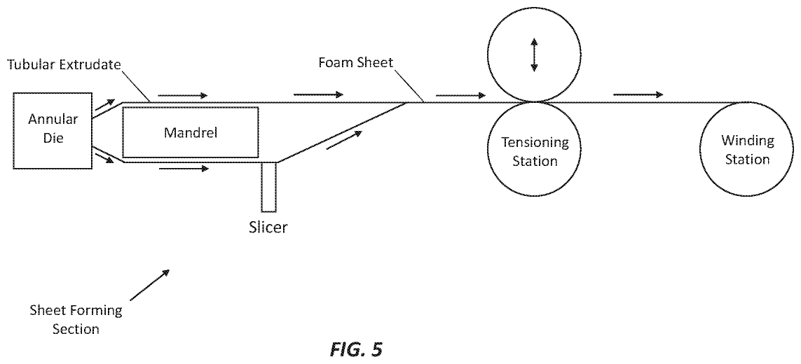

An exemplary sheet forming section is depicted in FIG. 5. As shown, the CE melt resin is extruded through an annular die and drawn over a forming mandrel. A cooling fluid (e.g., air) may be flowed across the interior and/or exterior of the extrudate to cool the extrudate material as it passes over the mandrel. For example, the cooling fluid may be blown from the mandrel toward the die to cool the interior surface of the extrudate between the die and mandrel. Additionally or alternative, the cooling fluid may be flowed across the mandrel to cool the exterior surface of the extrudate as it passes over the mandrel.

A slicer (or slitting device) may be used to open the tubular extrudate, which allows the tubular shape to be formed into a flat sheet. For example, the tubular extrudate passing over the mandrel may be slit and drawn to a tensioning station comprising one or more rollers that flatten the extrudate and maintain a necessary amount of tension on the extrudate to continue pulling the extrudate over the mandrel. The flattened extrudate will generally be in the form of a sheet, which may then be directed to a winding station where the material may be rolled for packaging and transportation.

Referring again to FIG. 1 and FIG. 2, the sheets produced by the sheet production process may be used to form foam articles, which are described in greater detail below. Such articles are particularly useful in the food service industry. Exemplary articles include meat trays. The articles may have one or more particularly advantageous properties. For example, the articles may be biodegradable and/or compostable, and/or the articles may have superior mechanical properties (e.g., strength, density, cell size, absorption, etc.).

### Compositions

The processes described above may comprise the preparation and extrusion of compositions that may be used for downstream processing to form useful articles. For example, in one embodiment or in combination with any other embodiment mentioned herein, the extrusion feed material may comprise a particulate material comprising a biodegradable polymer and optionally one or more additive(s), such as those described herein. In one embodiment or in combination with any other embodiment mentioned herein, the feed material may be combined with one or more additive(s), such as those described herein, to provide a mixed composition comprising the biodegradable polymer and the one or more additive(s). In one embodiment or in combination with any other embodiment mentioned herein, the biodegradable polymer comprises a cellulose ester.

In one embodiment or in combination with any other embodiment mentioned herein, the cellulose ester composition comprises one or more polymers and/or other additives operable to enhance the melt strength of the composition and/or otherwise increase the elasticity of the composition (and the resulting foamed articles). Such polymers and other additives can allow the foamed sheets to be thermoformed at higher draw ratios as compared to foamed sheets without these polymers and/or additives. For example, in some embodiments, the compositions comprise 1% to 50%, or 2% to 20% by weight of the one or more such polymers and/or other additives. In some embodiments, the composition comprises at least one additive having a specific heat capacity of at least 2000 J/kg-C. In some such embodiments, the one or more additives are selected from C20-C40 hydrocarbons (e.g., paraffin wax), C12-C16 fatty acids, biodegradable polymers (such as polyethylene glycol (PEG) and others described herein), and/or melt strength enhancers (such as functional ionic components). In some embodiments, the composition comprises at least one additive having a specific heat capacity of at least 2000 J/kg-C and a melt strength enhancer.

Additional details of the composition components, including biodegradable polymers (e.g., cellulose esters) and other additives, are provided below.

### Cellulose Ester

The cellulose esters utilized as described herein can be any that is known in the art. Cellulose ester that can be used for embodiments herein generally comprise repeating units of the structure:

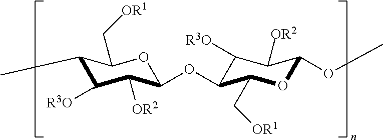

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). If the DS refers to the acetyl substituents, DS may be expressed as the DSAc. In certain situations, the DS may be expressed as DSOH which describes the average free hydroxyl groups. Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In one embodiment or in combination with any other embodiment, n is an integer in a range from 25 to 250, or 25 to 200, or 25 to 150, or 25 to 100, or 25 to 75.

In one embodiment or in combination with any other embodiment, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In one embodiment or in combination with any other embodiment, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In one embodiment or in combination with any other embodiment, cellulose esters useful herein can have a DS/AGU of about 1 to about 3.0, or of about 2.0 to 2.9, or of about 2.2 to about 2.8, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In one embodiment or in combination with any other embodiment, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10, Eastman™ CAP 485-20 cellulose acetate propionate; Eastman™ CAB 381-2 cellulose acetate butyrate.

In one embodiment or in combination with any other embodiment, the cellulose ester can be prepared by converting cellulose to a cellulose ester with reactants that are obtained from recycled materials, e.g., a recycled plastic content syngas source. In one embodiment or in combination with any other embodiment, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose ester composition comprising at least one recycle cellulose ester is provided, wherein the cellulose ester has at least one substituent on an anhydroglucose unit (AU) derived from recycled content material, e.g., recycled plastic content syngas.

In one embodiment or in combination with any other embodiment, the cellulose ester composition comprises cellulose ester in an amount from 50 to 99 wt %, or 60 to 99 wt %, or 70 to 99 wt %, or 80 to 99 wt %, or 90 to 99 wt %, 50 to 90 wt %, or 60 to 90 wt %, or 70 to 90 wt %, or 80 to 90 wt %, or 90 to 99 wt %, or 50 to 80 wt %, or 60 to 80 wt %, or 70 to 80 wt %, or 50 to 70 wt %, or 60 to 70 wt %, or 50 to 60 wt %, all based on the total weight of the cellulose ester composition. In some embodiments, the cellulose ester used herein may comprise a combination, blend, or mixture of two or more different types of cellulose esters. For example, in some embodiments, the cellulose esters used herein may be comprised of a blend of two or cellulose esters having differing DSACs; however, the blend may have an total DSAC of between 2.2 and 2.8 or of between 2.0 and 2.9.

### Plasticizer

In one embodiment or in combination with any other embodiment, the cellulose ester compositions described herein can comprise at least one plasticizer. The plasticizer reduces the melt temperature, i.e., the Tg, and/or the melt viscosity of the cellulose ester. Plasticizers for cellulose esters may include glycerol triacetate (Triacetin), glycerol diacetate (Diacetin), dibutyl terephthalate, dimethyl phthalate, diethyl phthalate, poly(ethylene glycol) MW 200-600, dibutyl tartrate, di-2-methoxyethyl phthalate, ethyl o-benzoylbenzoate, triethylene glycol dipropionate, 1,2-epoxypropylphenyl ethylene glycol, 1,2-epoxypropyl (m-cresyl)ethylene glycol, 1,2-epoxypropyl (o-cresyl)ethylene glycol, β-oxyethyl cyclohexenecarboxylate, bis(cyclohexanate) diethylene glycol, triethyl citrate, polyethylene glycol, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, the benzoate containing plasticizers such as the Benzoflex™ plasticizer series, poly (alkyl succinates) such as poly (butyl succinate), polyethersulfones, o-Cresyl p-toluenesulfonate, n-ethyltoluenesulfonamides, adipate based plasticizers, soybean oil epoxides such as the Paraplex™ plasticizer series, sucrose based plasticizers, dibutyl sebacate, tributyrin, sucrose acetate isobutyrate, the Resolflex™ series of plasticizers, triphenyl phosphate (TPP), triethyl phosphate (TEP), glycolates (e.g., ethyl phthalyl ethyl glycolate “EPEG” and methyl phthalyl ethyl glycolate “MPEG”), methoxy polyethylene glycol, 2,2,4-trimethylpentane-1,3-diyl bis(2-methylpropanoate), and polycaprolactones. In some embodiments, the plasticizer used herein may comprise a combination or mixture of two or more different types of plasticizers.

In one embodiment or in combination with any other embodiment, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In one embodiment or in combination with any other embodiment, the food-compliant plasticizer is triacetin or polyethylene glycol (PEG) having a molecular weight of about 200 to about 600. In one embodiment or in combination with any other embodiment, examples of food-compliant plasticizers that could be considered can include triacetin, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one embodiment or in combination with any other embodiment, the plasticizer can be present in an amount sufficient to permit the cellulose ester composition to be melt processed (or thermally formed) into useful articles, e.g., single use plastic articles, in conventional melt processing equipment. In one embodiment or in combination with any other embodiment, the plasticizer is present in an amount from 1 to 40 wt % for most thermoplastics processing; or 5 to 25 wt %, or 10 to 25 wt %, or 12 to 20 wt % based on the weight of the cellulose ester composition. In one embodiment or in combination with any other embodiment, profile extrusion, sheet extrusion, thermoforming, and injection molding can be accomplished with plasticizer levels in the 10-30, or 12-25, or 15-20, or 10-25 wt % range, based on the weight of the cellulose ester composition.

In one embodiment or in combination with any other embodiment, the plasticizer is a biodegradable plasticizer. Some examples of biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol, 2,2,4-trimethylpentane-1,3-diyl bis(2-methylpropanoate), and polycaprolactones.

In one embodiment or in combination with any other embodiment, the cellulose ester composition can contain a plasticizer selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In one embodiment or in combination with any other embodiment, the cellulose ester composition comprises at least one plasticizer (as described herein) in an amount from 1 to 40 wt %, or 5 to 40 wt %, or 10 to 40 wt %, or 12 to 40 wt %, 13 to 40 wt %, or 15 to 40 wt %, or greater than 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the cellulose ester composition.

In one embodiment or in combination with any other embodiment, the at least one plasticizer includes or is a food-compliant or FDA approved plasticizer. In one embodiment or in combination with any other embodiment, the food-compliant or FDA approved plasticizer includes or is triacetin or PEG MW 300 to 500.

### Biodegradable Polymers

In one embodiment or in combination with any other embodiment, the cellulose ester compositions described herein comprise a biodegradable cellulose ester (BCE) component that comprises at least one BCE, which may include one or more of the cellulose esters described herein, and a biodegradable polymer component that comprises at least one other biodegradable polymer (other than the BCE). In one embodiment or in combination with any other embodiment, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In one embodiment or in combination with any other embodiment, the cellulose ester composition comprises two or more biodegradable polymers. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the cellulose ester composition. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the total amount of BCE and biodegradable polymer. In one embodiment or in combination with any other embodiment, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In one embodiment or in combination with any other embodiment, the PHA can include a polyhydroxybutyrate-co-hydroxyhexanoate.

### Nucleating Agent

Nucleating agent means a chemical or physical material that provides sites for cells to form in a molten formulation mixture, such as within a CE melt resin. As will be described in more detail below, nucleating agents may be added to compounded CE material during the compounding process. Alternatively, or in addition, nucleating agents may be added during the foam sheet production process. For example, the nucleating agents may be blended with the formulation that is introduced into the hopper of the extruder of the extruding section. Alternatively, the nucleating agents may be added to the CE melt resin in the extruder itself. Nucleating agents may include physical nucleating agents and chemical nucleating agents. Physical nucleating agents are materials that are immiscible with the polymer matrix of the CE melt resin at the extrusion temperature of the extrusion section. Chemical nucleating agents are materials that react (e.g., decompose) during extrusion (e.g., at the extrusion temperature within the extruder) to form physical nucleating agents. Thus, chemical nucleating agents may be considered (and referred to herein as) precursors of in situ formed physical nucleating agents.

Suitable physical nucleating agents will comprise fine particles having desirable particle sizes and/or shapes to create cell nucleation sites within the CE melt resin. For example, in some embodiments, physical nucleating agents will have a mean particle size of less than 1000 microns, less than 500 microns, less than 100 microns, less than 50 microns, less than 25 microns, less than 20 microns, less than 10 microns, less than 5 microns, less than 2 microns, less than 1.5 microns, and/or less than 1.0 microns. However, in some other embodiments, it may be preferred to have nanoscale-sized particles. Furthermore, it some embodiments, physical nucleating agents will preferably have a high aspect ratio (i.e., width: height). For example, in some embodiments, physical nucleating agents will have a mean aspect ratio of greater than 1:1, greater than 2:1, greater than 5:1, greater than 10:1, greater than 20:1, greater than 30:1, greater than 40:1, greater than 50:1, greater than 75:1, and/or greater than 100:1. Furthermore still, as noted above, physical nucleating agents should be immiscible with the polymer matrix of the CE melt resin at the extrusion temperature of the extrusion section. As such, in some embodiments, the physical nucleating agents should have a melting temperature at least 220° C., at least 230° C. of at least 240° C., at least 250° C., at least 275° C., at least 300° C., at least 325° C., or at least 350° C. Nevertheless, the physical nucleating agents may be selected such that they have the ability to, after melting, recrystallize upon cooling.

Examples of suitable inorganic physical nucleating agents include, but are not limited to, minerals such as talc, CaCO₃, mica, and mixtures of at least two of the foregoing. One representative example is Heritage Plastics HT6000 Linear Low Density Polyethylene (LLDPE) Based Talc Concentrate. Other inorganic physical nucleating agents include wollastonite, silica, silicon oxide, titanium oxide, magnesium oxide, aluminum oxide and calcium silicate, barium sulfate, Kaolin, aluminum tryhydrateATH (Al(OH)₃), MDH (Mg(OH)₂), Diatomaceous earth, magnetite/hematite, halloysite, zinc oxide, and titanium dioxide. In some embodiments, the inorganic nucleating agents will comprise oxides, such as metal oxides or mixed metal oxides, such as those selected from one or more of the following: aluminum oxide, antimony oxide, arsenic oxide, bismuth oxide, boron oxide, calcium oxide, gallium oxide, iron oxide, lithium oxide, magnesium oxide, silicon oxide, and titanium oxide. In other embodiments, the inorganic nucleating agents will comprise silicates, such as silicates selected from one or of the following: magnesium silicate and calcium silicate.

It has been discovered that biodegradable natural, particulate materials derived from renewable organic sources (e.g., organic nucleating agents) can also serve as effective physical nucleating agents. Natural materials that can be physical nucleating agents include material comprised of cellulose fibers and/or cellulose starch. Examples include, but are not limited to almond shell flour, animal fiber, apricot shell flour, bamboo flour, tree bark flour, clam shell flour, coconut shell flour, coconut coir, cork flour, corn cob flour, corn cob grit, cottonseed hulls, flock & fiber, hazelnut shell flour, kenaf flour, natural fibers, nutshell hull & flour, oat fiber powder, olive stone flour, peanut hulls flour, pecan shell flour, pine-nut shell powder, pistachio-nut shell flour, plant fiber, rice hull flour, rice hull grit, rice husk, soy bean flour, starch flour (hydrophobic), walnut shell flour, wheat chaff, wheat husk, and wood flour. Other organic physical nucleating agents include cellulose powder, chitin, chitosan, stearic acid metal salts, carbon black, and dolomite.

As noted above, suitable chemical nucleating agents (or precursors of in situ formed physical nucleating agents) are configured to decompose to create cell nucleation sites in the CE melt resin when a threshold chemical reaction temperature is reached. These small cells act as nucleation sites for larger cell growth from a physical or other type of blowing agent. In some embodiments, the precursors are configured to form a gas during extrusion of the particulate material, such as CO₂ or N₂.

Examples of chemical nucleating agents include but are not limited to acids, such as citric acid or a citric acid-based material. Other acids may include lauric acid, stearic acid, tartaric acid, ascorbic acid, propionic acid, and hexanoic acid. One representative example is HYDROCEROL™ CF-40E (available from Clariant Corporation), which contains citric acid and a crystal nucleating agent. In some embodiments, the chemical nucleating agents will include a combination of an acid and a base, such as a carbonate, which may include sodium bicarbonate, zinc bicarbonate, potassium bicarbonate, sodium carbonate, potassium carbonate, etc. For instance, a representative example of a chemical nucleating agent is a combination of citric acid and sodium bicarbonate. In some embodiments, chemical nucleating agents may include a carrier within which the active components of the nucleating agents are dispersed. For example, yet another representative example of chemical nucleating agents is a combination of citric acid, sodium bicarbonate, and a carrier. In some embodiments, the carrier may comprise polystyrene. However, the carrier may comprise other compositions, such as various biopolymers (e.g., polybutylene succinate, Capa polyesters, etc.), polyolefins, acrylic copolymers (e.g., ethylene methyl acrylate), or the like. In some such embodiments, the citric acid and sodium bicarbonate may comprise about half (in wt %) of the chemical nucleating agents, while the carrier makes up the remaining half (in wt %). Furthermore, in some of such embodiments, there may be more sodium bicarbonate than citric acid in the chemical nucleating agent. For instance, there may be about three times as much (in wt %) sodium bicarbonate than citric acid in the chemical nucleating agent. It should also be understood that in some embodiments, no carrier may be required or used, such as the case with the nucleating agent being Hecofoam or Hydrocerol.

In one embodiment or in combination with any of the embodiments mentioned herein, the nucleating agents are present at from 0.1 to 10 wt %, from 0.1 to 5.0 wt %, at least 0.1 wt %, at least 0.25 wt %, at least 0.5 wt % at least 1.0 wt %, at least 1.25 wt %, at least 1.5 wt %, at least 1.75 wt %, at least 2.0 wt %, at least 2.25 wt %, at least 2.5 wt %, at least 2.75 wt %, or at least 3.0 wt %, or at least 3.5 wt %, or at least 4.0 wt %, or at least 4.5 wt % and/or less than 7.5 wt %, less than 5 wt %, less than 4 wt %, less than 3 wt %, less than 2 wt %, or less than 1.0 wt %, all based on the total weight of the cellulose ester composition. In some embodiments, the nucleating agents used herein may comprise a combination or mixture of two or more different types of nucleating agents.

It is noted that the cellulose ester material, whether in the form of compounded CE material or CE melt resin, will generally be able to accept a maximum amount of nucleating agent that can function to form nucleation sites. Any remaining nucleating agent that is added to the cellulose ester material will remain as filler. Fillers can provide various properties to the resulting cellulose ester foams and/or articles based on the type of filler used. For example, some fillers can provide increased/decreased density, ductility, Young's modulus, yield strength, heat deflection temperature, permeability, impact resistance, elongation to break, adhesion properties, biodegradation, etc. of the cellulose ester material. Fillers can also be used to alter the visual characteristics (e.g., color, opacity, etc.) and tactile characteristics (e.g., material continuous, surface roughness, etc.) of the cellulose ester material.

### Blowing Agents

A blowing agent refers to a physical or a chemical material (or combination of materials) that acts to expand nucleation sites. Blowing agents may include chemical blowing agents, physical blowing agents, combinations thereof, or several types of chemical and physical blowing agents. The blowing agents function to reduce density of a material by expanding cells formed in the molten formulation at the nucleation sites. The blowing agent may be added to the CE melt resin in the extruder. It has been surprisingly discovered that the hygroscopic nature of biodegradable particulate natural fillers allows them to absorb moisture and carry the absorbed water into the molten resin mixture where the water can act as a physical blowing agent.

Examples of physical blowing agents include H₂O, N₂, CO₂, alkanes, alkenes, ethers, ketones, argon, helium, air or mixtures. In addition, it has been surprisingly discovered that the hygroscopic nature of biodegradable particulate natural fillers allows them to absorb moisture and carry the absorbed water into the molten resin mixture where the water can act as a physical blowing agent. Hygroscopic biodegradable natural fillers can be formulated into a composition and allowed to absorb moisture prior to the foaming process, where the water then is released to act as a physical blowing agent. Beneficially, the water may also be used as a plasticizer for the cellulose ester resin. Furthermore, in some embodiments, physical blowing agents may include hydrocarbons, such as pentane/isopentane or butane/isobutane. Other hydrocarbons may include propane, ethane, methane, hexane, cyclohexane, cyclopentane, cyclobutene, or the like.

Chemical blowing agents are materials that degrade or react to produce a gas (e.g., CO₂ or N₂). Such gasses expand the cells within the molten resin mixture and/or resulting foam mixture to produce a structural material with a plurality of gaseous voids dispersed throughout. Chemical blowing agents may be endothermic or exothermic. Chemical blowing agents typically degrade at a certain temperature to decompose and release gas. Examples of chemical blowing agents include azodicarbonamide, acids (e.g., citric acid), and carbonates, such as sodium bicarbonate, sodium carbonate, ammonium bicarbonate, ammonium carbonate, zinc carbonate, and the like and combinations thereof.

In one embodiment or in combination with any of the embodiments mentioned herein, the blowing agent is present at from 0.3 to 1.5 wt %, or 0.3 to 2.0 wt %, or 0.3 to 2.5 wt %, or 0.3 to 3.0 wt %, or 0.3 to 3.5 wt %, or 0.3 to 4.0 wt %, or 0.3 to 8%, or 1.3 to 1.5 wt %, or 1.3 to 2.0 wt %, or 1.3 to 2.5 wt %, or 1.3 to 3.0 wt %, or 1.3 to 3.5 wt %, or 1.3 to 4.0 wt %, or 1.3 to 4.5 wt %, or 1.3 to 5.0 wt %, or 1.3 to 5.5 wt %, or 1.5 to 3.0 wt %, or 1.5 to 4.0 wt %, or 1.5 to 5.0 wt %, or 1.5 to 6.0 wt %, or 2.0 to 3.0 wt %, or 2.0 to 4.0 wt %, or 2.0 to 5.0 wt %, or 2.0 to 6.0 wt %, or 2.5 to 3.0 wt %, or 2.5 to 4.0 wt %, or 2.5 to 5.0 wt %, or 2.5 to 6.0 wt %, or 3.0 to 4.0 wt %, or 3.0 to 5.0 wt %, or 3.0 to 6.0 wt %, or 0.0 to 9.0 wt %, or 0.5 to 9.0 wt %, or 1.0 to 9.0 wt %, or 1.5 to 9.0 wt %, or 2.0 to 9.0 wt %, or 2.5 to 9.0 wt %, or 3.0 to 9.0 wt %, or 3.5 to 9.0 wt %, or 4.0 to 9.0 wt %, or 4.5 to 9.0 wt %, or 5.0 to 9.0 wt %, or 5.5 to 9.0 wt %, or 6.0 to 9.0 wt %, or 6.5 to 9.0 wt %, or 7.0 to 9.0 wt %, or 7.5 to 9.0 wt %, or 8.0 to 9.0 wt %, or 8.5 to 9.0 wt %, all based on the total weight of the cellulose ester composition. In some embodiments, the blowing agents used herein may comprise a combination or mixture of two or more different types of blowing agents.

### Surface Modifying Additives

Surface modifying additives refer to materials that can be added to cellulose ester compositions to modify the structure of the compositions (or the resulting foam articles) to improve processing of the cellulose ester compositions. For example, the inventors of the present application have found that adding surface modifying additives to the compounded CE material (e.g., to the pellets during the compounding process) or to the CE melt resin (e.g., during the extrusion process) can improve processing by reducing unwanted sticking of the CE melt resin to the die or mandrel (or to other components of the foam sheet production process). Such reduction in sticking may be achieved by the surface modifying additives inhibiting the fusing of cellulose esters caused by plasticizers. The addition of surface modifying additives may also reduce blocking of the cellulose ester foam sheets produced at the sheet forming section. Furthermore, surface modifying additives may also improve the foam sheet production process by allowing the process to be performed at lower temperatures.

Furthermore still, in some embodiments, the surface modifying additives may function as anti-static additives, which inhibit electrical sparks or arcing in the CE melt resin. The inhibition of electrical sparks or arcing can be particularly important when hydrocarbons are used as blowing agents, so as to reduce the chance of igniting the hydrocarbons and causing fires. Beneficially, surface modifying additives may also reduce the diffusion of blowing agents, such as hydrocarbons, out of the foam sheets or resulting articles. In some embodiments, hydrocarbons themselves may be used as surface modifying additives.

Nevertheless, more general examples of surface modifying additives that may be used with compounded CE material (e.g., during the compounding process) or to the CE melt resin (e.g., during the foam sheet production process) according to embodiments of the present invention include fatty acids, such as palmitic acid, tallow acid, stearic acid, oleic acid, linoleic and linolenic acids, arachidic/behenic acids, behenic acid, and erucic acid. Surface modifying additives may also include fatty acid amides, such as erucamides, oleoamides, stearmides, bhenamides, secondary amides, and bisamides.

Additional examples of surface modifying additives may include glycerol esters and/or stearate esters, such as monoglycerides, diglycerides, and triglycerides. The monoglycerides may include glycerol monostearate or monoglyceride derivatives, such as diacetyl tartaric acid esters of mono- and diglycerides (DATEM), ethoxylated monoglyceride, succinyl monoglyceride, and propylene glycol monoesters (PGME). Examples of surface modifying additives may also include metallic stearates such as aluminum stearate, calcium stearate, lithium stearate, magnesium stearate, sodium stearate, zinc stearate, and/or combinations thereof (e.g., Calcium/Zinc stearates). Examples of surface modifying additives may also include waxes, such as polyolefin waxes (polypropylene wax and polyethylene wax), oxidized olefin waxes, ethylene acrylic acid (EAA) copolymer waxes, ethylene methyl acrylate (EMA) copolymer waxes, EAA ionomer axes, acrylic waxes, and/or natural waxes, such as rice bran wax, sunflower wax, sugar cane wax, candelilla wax, soy wax, bees wax, candelilla wax, and carnauba waxes.

Other, non-exclusive examples of surface modifying additives include aliphatic diesters (e.g., dioctyl adipate), polyglycol diesters, alkyl alkyether diesters, aromatic triesters, polyester resins, chlorinated hydrocarbons, halogenated hydrocarbons, alkylether monoesters, and alkyl monoesters. In addition, various oils may be used as surface modifying additives, such as aromatic oils, napthenic oils, glyceride oils, silicon oils, and epoxidized oils (e.g., soybean oil and linseed oil). Thus, in some embodiments, the surface modifying additives comprise plasticizers, such as aliphatic diester plasticizers, polyester plasticizers, and the like. Furthermore, in some embodiments, surface modifying additives may comprise a polyhedral oligomeric silsesquioxane (POSS).

More generally, surface modifying additives used in embodiments of the present invention may have a lower polarity than the cellulose ester in compounded CE material (e.g., during the compounding process) or to the CE melt resin (e.g., during the foam sheet production process). For example, the surface modifying additives may have (based on Hansen solubility parameters): a total solubility parameter o of less than 25 MPa^{1/2}, less than 20 MPa^{1/2}, or less than 19.5 MPa^{1/2}; a dispersion force solubility parameter Od of less than 18 MPa^{1/2}, less than 16 MPa^{1/2}, or less than 14 MPa^{1/2}; a dipolar intermolecular force solubility parameter od of less than 12 MPa^{1/2}, less than 8 MPa^{1/2}, or less than 4 MPa^{1/2}; and/or a hydrogen bond solubility parameter On of less than 11 MPa^{1/2}, less than 10 MPa^{1/2}, or less than 9 MPa^{1/2}. However, in some other embodiments, the surface modifying additives used in embodiments of the present invention may have a higher polarity than the cellulose ester in compounded CE material (e.g., during the compounding process) or to the CE melt resin (e.g., during the foam sheet production process). For example, the surface modifying additives may have (based on Hansen solubility parameters): a total solubility parameter o of more than 21.5 MPa^{1/2}, more than 23 MPa^{1/2}, or more than 25 MPa^{1/2}. In addition, in some embodiments, surface modifying additives may have a boiling point greater than 200° C., greater than 220° C., greater than 240° C., greater than 260° C., greater than 280° C., or greater than 300° C. Furthermore, the surface modifying additives may have a molecular weight greater than 100 g/mol, greater than 150 g/mol, greater than 220 g/mol, greater than 260 g/mol, greater than 300 g/mol, or greater than 340 g/mol and/or no more than 1000 g/mol, no more than 2500 g/mol, or no more than 5000 g/mol. Furthermore still, it may be preferable for the surface modifying additives to not be soluble in the plasticizer(s) used in the cellulose ester compositions. For instance, it may be preferable for the surface modifying additives to not be soluble in triacetin. Finally, in some embodiments, the surface modifying additives may be biodegradable and/or food-compliant or FDA approved.

In one embodiment or in combination with any of the embodiments mentioned herein, the surface modifying additives are present at from 0.05 to 0.75 wt %, or 0.05 to 1.0 wt %, or 0.05 to 2.5 wt %, or 0.05 to 5.0 wt %, or 0.75 to 1.0 wt %, or 0.75 to 2.5 wt %, or 0.75 to 5.0 wt %, or 0.1 to 1.0 wt %, or 0.1 to 2.5 wt %, 0.1 to 5.0 wt %, or 1.0 to 2.5 wt %, or 1.0 to 5.0 wt %, or 2.5 to 5.0 wt %, all based on the total weight of the cellulose ester composition. In some embodiments, the surface modifying additives used herein may comprise a combination or mixture of two or more different types of surface modifying additives.

### Melt Strength Enhancers

The elasticity of the cellulose ester compositions, and particularly during heated processes such as extrusion and thermoforming, may be increased by including one or more melt strength enhancers. Such melt strength enhancers may be in the form of functional ionic components. A variety of compounds and materials may be used so long as they include ionic functional groups. For example, in some embodiments, the functional ionic component is selected from the group consisting of acacia gum, sulfopolyesters, quaternary salts, ionomers, ionic liquids, ionic waxes, and mixtures thereof.

### Articles

Extruded sheets of cellulose ester foam may be formed using the extrusion section and/or the sheet forming section described above. Such extruded sheets comprise a structural material with a plurality of gaseous voids disposed throughout. Such gaseous voids are formed by expansion of the blowing agent in the form of a gas within the cellulose polymer melt. The structural material is cellulose ester based, with specific amounts of the compositional components of the structural material (e.g., cellulose ester, plasticizer, nucleating agents, surface modifying additives, etc.) having been described above in more detail. Articles may be formed from the extruded sheets of foam in accordance with embodiments, and may be particularly useful in the food service industry. Exemplary articles include meat trays. The articles may have one or more particularly advantageous properties. For example, the articles may have preferential water absorption properties, be biodegradable and/or compostable, and/or the articles may have superior mechanical properties (e.g., strength, density, cell size, absorption, etc.).

Such cellulose ester foamed articles may be formed from the cellulose ester foamed sheets by thermoforming, in which heat and optionally pressure are applied to the foamed sheet within a mold to create a three-dimensional article that retains its shape after release from the mold. For example, in some embodiments, the foamed sheets will be heated to a surface temperature from 40-100° C., from 50-80° C., or from 50-70° C. greater than the Tg of the foamed sheet. In some embodiments, the Tg of the foamed sheet will be about 120° C. As such, the thermoforming process may heat the foamed sheet to a surface temperature from 150-210° C. or from 160-200° C. In some embodiments, even heat distribution through the foamed sheet can be achieved by heating at lower temperatures (e.g., 40-70° C. above the Tg, or 150-180° C.), which may require longer heating times.

In more detail, embodiments of the present invention may include a foamed article in the form of a foamed tray. The foamed tray may be configured as a food tray to support one or more food items such as meat. Alternatively, the food items are proteins (e.g., animal, plant), vegetables, or fruits. As illustrated, the foamed tray may include a base that is substantially planar, as well as a rim that is raised above the base and extends around the periphery of the foamed tray. The top surface of the base and the surrounding rim define a receiving area (e.g., a bowl) within which items (e.g., meat or another foodstuff) may be held and supported.

Foamed trays formed according to embodiments of the present invention may be formed in various sizes. For example, the tray may have a width “W” in the range of 2-12 inches, 3-10 inches, or 5-9 inches and a length “L” from 4-24 inches, 5-18 inches, or 6-15 inches. Thus, in some embodiments, the tray may have a length that is 1.2-4 times, 1.4-3 times, or 1.5-2 times the width of the tray.

The foamed tray may include a base that is substantially planar, as well as a rim that is raised above the base and extends around the periphery of the foamed tray. The top surface of the base and the surrounding rim define a receiving area (e.g., a bowl) within which items (e.g., meat, cheese, vegetables, fruits, or other foodstuff) may be held and supported. An area of the base may be from 5-100 square inches, 10-75 square inches, or 20-50 square inches. A rim heigh height (measured from a bottom of the tray to a top of the rim) may be from 0.2-4 inches, 0.4-2 inches, or 0.5-1 inch, and the rim width (i.e., a lateral distance “Rw” measured from a side of the tray to the point at which the rim meets the base) may be from 0.06-0.75 inches, 0.10-0.05 inches, or 0.25-0.50 inches. Alternatively, the rim width “Rw” may be from about 0.03 W to 0.06 W. A ratio of the base area to the rim area may be from 1-10, 1.5-6, or 2-4. In addition, the tray may have a depth (measured from a top of the rim to the top of the base) from 0.3 to 4 inches, from 0.5 to 3 inches, from 1 to 3 inches, from 1 to 2 inches, from 1.25 to 2 inches, about 1.25 inches, or about 1.5 inches. Furthermore, the tray may have a thickness (i.e., the thickness of the cellulose ester foam material) from 1 to 10 mm, from 1 to 8 mm, from 2 to 8 mm, from 3 to 7 mm, from 4 to 6 mm, about 4 mm, about 5 mm, or about 6 mm, and/or less than 5 mm, less than 4 mm, less than 3 mm, or less than 2 mm. Alternatively, or in addition, the tray or other article may have a thickness (i.e., the thickness of the cellulose ester foam material) from 100-400 mils, 120-300 mils, 150-250 mils.

Beneficially, the foamed tray may have preferential water absorption properties. For instance, when the foamed tray is used to support meat, it may be preferable for the tray to not to absorb liquid emitted from the meat. Foamed trays may be tested for water absorption, using the “Water Absorption Test,” which includes the following steps: (1) weighing the foamed tray to obtain an original tray weight; (2) filling the receiving area of the tray with water until the water reaches the top of the rim; (3) allowing the water-filled foamed tray to equilibrate at room temperature for either one hour or overnight (i.e., eighteen hours); (4) emptying the tray of the water supported in the receiving area; (5) lightly wiping down the tray to remove any excess water remaining on the surface of the tray; (6) weighing the water-exposed tray to obtain a water-exposed tray weight; and (7) calculating the percentage weight gain of the water-exposed tray weight relative to the original tray weight.

According to embodiments of the present invention, after an inventive tray is filled with water and allowed to equilibrate at room temperature for one hour, the tray (after removing the water from the receiving area of the tray) can have a weight gain of less than 10%, less than 9%, less than 8%, less than 7%, less than 6%, less than 5%, and/or less than 4%. Alternatively, or in addition, after an inventive tray is filled with water and allowed to equilibrate at room temperature overnight (e.g., 18 hours or 24 hours), the tray (after removing the water from the receiving area of the tray) may have a weight gain of less than 20%, less than 15%, less than 14%, less than 13%, less than 12%, less than 11%, and/or less than 10.5%.

### Abbreviations

ADR is areal draw ratio; BA is blowing agent; d is density; TA is triacetin; Pent is pentane; PBA is physical blowing agent; cc or cm³ is centimeters cubed; Pz is plasticizer; O/N is overnight; Wt is weight; Temp is temperature; h is hour(s)

After the Water Absorption Test, the foamed trays can further undergo a “Freeze-Thaw Test” to test the ability of the trays to absorb water after experiencing a freeze-thaw cycle. The Freeze-Thaw Test includes the following steps: (1) freezing the trays overnight (i.e., eighteen h) within a freezer; (2) removing the frozen trays from the freezer; (3) leaving the frozen trays to thaw at room temperature overnight (i.e., eighteen h); (4) filling the receiving area of the thawed foamed tray with water; (5) allowing the filled tray to equilibrate at room temperature for twelve hours; (6) emptying the tray of the water supported in the receiving area; (7) lightly wiping down the emptied tray to remove any excess water remaining on the surface of the tray, (8) weighing the water-exposed tray to obtain a water-exposed tray weight; and (9) calculating the percentage weight gain of the water-exposed tray weight relative to the original weight of the tray. According to embodiments of the present invention, after a tray has undergone the Water Absorption Test and further when the tray is frozen overnight (i.e., eighteen h), thawed overnight (i.e., eighteen hours), filled with water, and allowed to equilibrate at room temperature for twelve hours, the tray may have a weight gain of less than 30%, less than 25%, less than 20%, and/or less than 15%.

Several sample trays were formed and tested using the Water Absorption Test and the Freeze-Thaw Test. The trays were formed from a cellulose ester foam sheet that was extruded using a tandem extruder system. The cellulose ester melt resin that was extruded comprised cellulose diacetate with a degree of substitution of 2.52, a melting point from 230-250° C., and a Tg of 189° C. The melt resin was plasticized with triacetin from 15 to 20 wt. % loading. Talc was used as a nucleating agent, which along with a physical blowing agent, was mixed into the melt resin within a twin screw extruder of the tandem extruder system. The resulting melt resin was transferred to a single screw extruder, with which an annular die was used to extrude a cellulose ester foam sheet. The foam sheet was stretched, cut, and thermoformed to form a foam tray. The results of four samples that underwent the one-hour Water Absorption Test are shown in Table 1. The results of four samples that underwent the eighteen-hour Water Absorption Test are shown in Table 2, and the results of two samples that underwent the Freeze-Thaw Test are shown in Table 3. It is noted that for each sample, at least three foamed trays were used and the measurements were averaged to provide the show results shown below.

TABLE 1

| | Mean 1 h |
|---|---|
| Sample | Gain (wt %) |
| 1 | 3.9 |
| 2 | 6.5 |
| 3 | 4.6 |
| 4 | 6.3 |

TABLE 2

| | Mean O/N Gain |
|---|---|
| Sample | (wt %) |
| 5 | 10.5 |
| 6 | 11.8 |
| 7 | 13.3 |
| 8 | 13.3 |

TABLE 3

| | O/N Wt Gain | Wt Gain after freeze |
|---|---|---|
| Sample | (wt %) | thaw cycle (wt %) |
| 9 | 14.3 | 14.9 |
| 10 | 24.1 | 26.4 |

Embodiments provide for the above described foamed trays to be formed according to the processes described herein. In particular, a mixed composition comprising cellulose ester can be extruded through an extruder and processed to form a cellulose ester foamed sheet. The foamed sheet can then be thermoformed to form a tray, which can include a generally planar base and a rim extending up from the base and around the periphery of the tray.

The thermoforming process generally comprises heating the foamed sheet to a desired temperature and stretching the foamed sheet into a mold having the appropriate dimensions for the foamed tray article. The amount that the flat foamed sheet is stretched in the mold can be characterized by the areal draw ratio. As used herein, the “areal draw ratio” refers to the total top surface area of the thermoformed tray (i.e., including the base and rim) divided by the areal footprint of the tray (i.e., the two-dimensional area of the tray when viewed from the top). For example, if a flat sheet is thermoformed into a tray having the dimensions 10 inches wide by 12 inches long by 2 inches deep, the total top area will be 208 square inches (2(10×2)+2(12×2)+(10×12)) and the areal footprint will be 120 square inches (10×12). Thus, the areal draw ratio of this tray is 1.7 (208/120). Traditional polystyrene meat trays typically have a draw ratio of about 1.5 to about 1.7.

In one embodiment or in combination with any of the embodiments mentioned herein, the cellulose ester foamed trays can therefore have a draw ratio of 1.2 to 5.0, 1.3 to 4.0, 1.4 to 3.0, or 1.5 to 2.0. That is, the foamed sheet can be thermoformed in a mold having a footprint area (X) and a surface area that is 1.2X to 5.0X, 1.3X to 4.0X, 1.4X to 3.0X, or 1.5X to 2.0X.

Several trays were formed having different areal draw ratios to test the effect of the draw ratio on skin integrity of the trays. Eastman CA-398-30 or Eastman FE700 (cellulose diacetate; CDA) was the resin for all examples and measurements. The degree of substitution (DS) was 2.52. Melting point was 230-250° C. and Tg 189° C. The formulations were plasticized with Triacetin (TA) at 15% and 20% loading. Talc (ABT-1000) was used as the nucleating agent. The extruded foam sheets were made using a tandem extruder setup. The physical blowing agent (CO₂ or pentane) and talc were mixed in the twin screw extruder (ZE 30) followed by transferring the melt to the single screw extruder (KE 60). An annular die was used to extrude the foam sheet tube before stretching and cutting the sheet open over a calibrator cylinder. The samples were thermoformed by heating to about 330° F. (320° F. to 360° F.) and stretching the sheets into molds at areal draw ratios of 1.97, 1.59, and 1.41.

The skin integrities of the trays having different plasticizer concentrations and areal draw ratios were tested by measuring water uptake using the Water Absorption Test described above. Each tray was filled to the rim with the water and allowed to equilibrate in lab environment for different amounts of time: 1 hour, 2 hours, 4 hours, 8 hours, 18 hours, 24 hours). After the set time, the water was drained out and trays lights wiped out and weight measured.

The skin integrities of the trays were also tested using the Freeze-Thaw Test described above. Each tray was frozen in the freezer overnight (~18 hours), followed thawing in lab environment overnight (~18 hours). The weights of the trays were measured and compared to the water-uptake before freeze-thaw cycle.

Table 4 shows the areal draw ratios of three different tray molds (having different draw ratios) used to thermoform two diacetate formulations (15% and 20% plasticizer). The water uptake was measured after 1 hour. At least 3 trays were measured to calculate the average and standard deviation.

TABLE 4

| | | | | | | Sheet | | Mean 1 h |
|---|---|---|---|---|---|---|---|---|
| | Pz | PBA | | Talc | Sheet d | Thickness | | Wt gain |
| Sample | (wt %) | (wt %) | | (wt %) | (g/cc) | (mils) | ADR | (wt %) |
| 11 | TA (20) | CO₂ | (1.5) | 2.5 | 0.142 | 122 | 1.97 | 13.5 |
| 12 | TA (15) | Pent | (2.3) | 2 | 0.115 | 118 | 1.97 | 20.8 |
| 13 | TA (20) | CO₂ | (1.5) | 2.5 | 0.142 | 122 | 1.59 | 3.9 |
| 14 | TA (15) | Pent | (2.3) | 2 | 0.115 | 118 | 1.59 | 6.5 |
| 15 | TA (20) | CO₂ | (1.5) | 2.5 | 0.142 | 122 | 1.41 | 4.6 |
| 16 | TA (15) | Pent | (2.3) | 2 | 0.115 | 118 | 1.41 | 6.3 |

Table 5 shows the areal draw ratios of three different tray molds used to thermoform two formulations (15 wt % and 20 wt % plasticizer). The water uptake was measured after overnight (~18 hours). At least 3 trays were measured to calculate the average and standard deviation.

TABLE 5

| | | | | | | | Mean | |
|---|---|---|---|---|---|---|---|---|
| | | | | | Sheet | | O/N Wt | Water |
| | Pz | PBA | Talc | Sheet d | Thickness | | Gain | leak |
| Sample | (wt %) | (wt %) | (wt %) | (g/cc) | (mils) | ADR | (wt %) | (O/N) |
| 17 | TA | CO₂ | 2.5 | 0.142 | 122 | 1.97 | 27.5 | Yes |
| | (20) | (1.5) | | | | | | |
| 18 | TA | Pent | 2 | 0.115 | 118 | 1.97 | 52.3 | Yes |
| | (15) | (2.3) | | | | | | |
| 19 | TA | CO₂ | 2.5 | 0.142 | 122 | 1.59 | 10.5 | No |
| | (20) | (1.5) | | | | | | |
| 20 | TA | Pent | 2 | 0.115 | 118 | 1.59 | 11.8 ± | No |
| | (15) | (2.3) | | | | | 0.7 | |
| 21 | TA | CO₂ | 2.5 | 0.142 | 122 | 1.41 | 13.3 ± | No |
| | (20) | (1.5) | | | | | 0.7 | |
| 22 | TA | Pent | 2 | 0.115 | 118 | 1.41 | 13.3 ± | No |
| | (15) | (2.3) | | | | | 1.9 | |

Table 6 shows the water uptake by trays with different areal draw ratio after overnight exposure to water, and after freeze-thaw cycle.

TABLE 6

| | | Wt Gain O/N | Wt Gain After Freeze |
|---|---|---|---|
| Sample | ADR | (wt %) | thaw cycle (wt %) |
| 18 | 1.97 | 55.3 | 77.4 |
| 19 | 1.59 | 14.3 | 14.9 |
| 21 | 1.41 | 24.1 | 26.4 |

Trays made with a areal draw ratio of 1.97 had visible defects (cracks) throughout the base of the tray. However, the trays with areal draw ratios of <1.6 did not have such defects.

The results above suggest that the cellulose ester trays thermoformed with intact skin absorbs about 10-25 wt % water, or about 15-20 wt % water, with absorption maximizing after about 1 day. Importantly, if the skin on the tray is broken/damaged during thermoforming, then the tray may absorb as much as about 40-50 wt % water, or more. Additionally, trays subjected to a freeze-thaw cycle and showed no significant change in water uptake for trays with intact skin. However, the water uptake of the tray thermoformed with areal draw ratio>1.9 (showing cracking) increased further after the freeze thaw cycle. Thus, the cellulose diacetate trays produced herein with areal draw ratios of 1.97 absorbed significantly more (>2X) water than the trays with areal draw ratios of 1.59 and 1.41.

In one embodiment or in combination with any of the embodiments mentioned herein, the cellulose ester foamed trays can therefore have a draw ratio that is less than 1.9, less than 1.8, less than 1.7, or less than 1.6. That is, the foamed sheet can be thermoformed in a mold having a footprint area (X) and a surface area that is less than 1.9X, less than 1.8X, less than 1.7X, or less than 1.6X. Such trays can be formed without visual cracking and increased water absorption. Thus, in some embodiments, when the foamed tray is filled with water and allowed to equilibrate at room temperature for one hour, the foamed tray has a weight gain of less than 10%, or less than 5%, according to the Water Absorption Test. In some embodiments, when the foamed tray is filled with water and allowed to equilibrate at room temperature for 18 hours, the foamed tray has a weight gain of less than 25%, or less than 15%, according to the Water Absorption Test. In some embodiments, when the foamed tray is frozen for 18 hours, thawed for 18 hours, filled with water, and allowed to equilibrate at room temperature for 12 hours, the foamed article has a weight gain of less than 30%, or less than 15%, according to the Freeze-Thaw Test.

In one embodiment or in combination with any of the embodiments mentioned herein, however, draw ratios of at least 1.6, at least 1.7, at least 1.8, at least 1.9, or even higher may be achieved. For example, foamed sheets formed from different compositions may improve the stretchability of the sheet during thermoforming so as to avoid cracking of the trays at higher draw ratios. For example, compositions comprising polymers and/or additives that adjust the elasticity, melt strength, and/or glass transition temperature (Tg) of the compositions can result in foams capable of increased draw ratios. Such polymers and additives include melt strength enhancers, such as those described herein, as well as components having a specific heat capacity of at least 2000 J/(kg K). Such polymers and additives can include, but are not limited to, functional ionic components, C20-C40 hydrocarbons (e.g., paraffin wax), C12-C16 fatty acids, polyethylene glycol (PEG) (e.g., MW 200-600), and mixtures thereof.

In one embodiment or in combination with any of the embodiments mentioned herein, the foamed articles, e.g., trays may have a density less than 0.20 g/cm³, less than 0.18 g/cm³, less than 0.15 g/cm³, less than 0.12 g/cm³, less than less than 0.10 g/cm³, less than 0.08 g/cm³, less than less than 0.06 g/cm³, or less than less than 0.04 g/cm³, or from 0.04 to 0.8 g/cm³, 0.04 to 0.6 g/cm³, 0.04 to 0.5 g/cm³, 0.04 to 0.4 g/cm³, 0.04 to 0.3 g/cm³, 0.04 to 0.2 g/cm³, 0.04 to 0.15 g/cm³, 0.04 to 0.12 g/cm³, 0.04 to 0.10 g/cm³, 0.04 to 0.08 g/cm³, 0.04 to 0.06 g/cm³, 0.06 to 0.8 g/cm³, 0.06 to 0.6 g/cm³, 0.06 to 0.5 g/cm³, 0.06 to 0.4 g/cm³, 0.06 to 0.3 g/cm³, 0.06 to 0.2 g/cm³, 0.06 to 0.15 g/cm³, 0.06 to 0.12 g/cm³, 0.06 to 0.10 g/cm³, 0.06 to 0.08 g/cm³, 0.08 to 0.8 g/cm³, 0.08 to 0.6 g/cm³, 0.08 to 0.5 g/cm³, 0.08 to 0.4 g/cm³, 0.08 to 0.3 g/cm³, 0.08 to 0.2 g/cm³, 0.08 to 0.15 g/cm³, 0.08 to 0.12 g/cm³, 0.08 to 0.10 g/cm³, 0.1 to 0.8 g/cm³, 0.1 to 0.6 g/cm³, 0.1 to 0.5 g/cm³, 0.1 to 0.4 g/cm³, 0.1 to 0.3 g/cm³, 0.1 to 0.2 g/cm³, 0.1 to 0.15 g/cm³, 0.1 to 0.12 g/cm³, 0.2 to 0.8 g/cm³, 0.2 to 0.6 g/cm³, 0.2 to 0.5 g/cm³, 0.2 to 0.4 g/cm³, 0.2 to 0.3 g/cm³, 0.3 to 0.6 g/cm³, 0.3 to 0.5 g/cm³, 0.3 to 0.4 g/cm³, 0.4 to 0.6 g/cm³, 0.4 to 0.5 g/cm³, or 0.5 to 0.6 g/cm³.

In one embodiment or in combination with any of the embodiments mentioned herein, the average foam cell size is from 40 μm to 600 μm, or 50 μm to 600 μm, or 60 μm to 600 μm, or 70 μm to 600 μm, or 80 μm to 600 μm, or 90 μm to 600 μm, or 100 μm to 600 μm, or 150 μm to 600 μm, or 200 μm to 600 μm, or 250 μm to 600 μm, or 300 μm to 600 μm, or 400 μm to 600 μm, or 500 μm to 600 μm, or 40 μm to 550 μm, or 40 μm to 500 μm, or 40 μm to 450 μm, or 40 μm to 400 μm, or 40 μm to 350 μm, or 40 μm to 300 μm, or 40 μm to 250 μm, or 40 μm to 200 μm, or 40 μm to 150 μm, or 40 μm to 100 μm.

Furthermore, it should be understood that because the foamed articles, e.g., trays, are formed from the cellulose ester described herein, the foamed articles may include any of the components and/or additives, as well as any resulting properties, of the cellulose ester based materials described herein.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth.

As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

In one embodiment or in combination with any of the embodiments mentioned herein, the biodegradable cellulose acetate foam or article is industrial compostable or home compostable. In one subclass of this class, the foam or article is industrial compostable. In one sub-subclass of this subclass, the foam or article has a thickness that is less than 6 mm. In one sub-subclass of this subclass, the foam or article has a thickness that is less than 3 mm. In one sub-subclass of this subclass, the article has a thickness that is less than 1.1 mm. In one subclass of this class, the foam or article is home compostable. In one sub-subclass of this subclass, the foam or article has a thickness that is less than 6 mm. In one sub-subclass of this subclass, the foam or article has a thickness that is less than 3 mm. In one sub-subclass of this subclass, the foam or article has a thickness that is less than 1.1 mm. In one sub-subclass of this subclass, the foam or article has a thickness that is less than 0.8 mm. In one sub-subclass of this subclass, the foam or article has a thickness that is less than 0.6 mm. In one sub-subclass of this subclass, the foam or article has a thickness that is less than 0.4 mm.

In one embodiment or in combination with any of the embodiments mentioned herein, the thickness of the foam or article is from 1 to 10 mm, from 1 to 8 mm, from 2 to 8 mm, from 3 to 7 mm, from 4 to 6 mm, about 4 mm, about 5 mm, about 6 mm, about 7 mm, or about 8 mm. However, it should be noted that the foam or article may have other, larger sizes. For example, in some embodiments, the foam or article may have a thickness from 0.5 to 24 inches, from 1 to 15 inches, or 3 to 12 inches.

In one embodiment or in combination with any of the embodiments mentioned herein, the foam sheet or articles (e.g., trays) exhibits greater than 90% disintegration after 12 weeks according to A Disintegration Test Protocol, as described below, or in the alternative according to ISO 16929 (2013). In some further embodiments, the foam sheet and/or articles (e.g., trays) made thereby may be at least 91, or at least 92, or at least 93, or at least 94, or at least 95, or at least 96, or at least 97, or at least 98, or at least 99, or at least 99.5 percent disintegrated within not more than 12, or not more than 11, or not more than 10, or not more than 9, or not more than 8 weeks according to the Disintegration Test Protocol, or according to ISO 16929 (2013).

The test method used for disintegration (referred to herein as the “Disintegration Test Protocol”) is based on ISO 16929 Plastics-Determination of the Degree of Disintegration of Plastics Materials under Defined Composting Conditions in a Pilot-Scale Test (2013). The foamed sheets or articles (e.g., trays) are formed into films having a thickness of about 0.25 mm (10 mil). Such films may be formed by cutting or shredding the foamed sheets or articles (e.g., trays). The films will generally have the same density as the original foamed sheets or articles (e.g., trays), such as no more than 0.20 g/cm³. The samples in their final form are mixed with fresh artificial bioresidue. Oxygen concentration, temperature and humidity are regularly controlled. After 12 weeks, the resulting composts are sieved and the remaining amount of material in pieces greater than 2 mm, if any, is determined.

As used herein, the “areal draw ratio” refers to the total top surface area of the thermoformed tray (i.e., including the base and rim) divided by the areal footprint of the tray (i.e., the two-dimensional area of the tray when viewed from the top). For example, if a flat sheet is thermoformed into a tray having the dimensions 10 inches wide by 12 inches long by 2 inches deep, the total top area will be 208 square inches (2(10×2)+2(12×2)+(10×12)) and the areal footprint will be 120 square inches (10×12). Thus, the areal draw ratio of this tray is 1.7 (208/120).

### Foam Sheet Manufacture

Foam sheet samples were made on a tandem foam line manufactured by Krauss Maffei. The extrusion lines consist of a ZE30 twin screw extruders as the primary extruder coupled to a KE60 single screw extruder as the secondary cooling extruder. Formulation additives are dosed in to the KE30 twin screw feeder using loss and weight feeders. Physical blowing agents are injected into the barrel of the primary extruder about ½ to ⅔ down the barrel of the primary extruder. Material is extruded out a 50 mm annual die and conveyed over a sizing mandrel. The annular film is then slit and turned into a flat film in the tension/take up station part of the roll.

The material composition includes cellulose acetate resin (Eastman CA-398-30 or Eastman FE700) having 15 to 20 weight % triacetin and stabilizers (1 wt % epoxidized soybean oil, 0.15 wt % Doverphos S9228T). The material is injected with n-pentane as the blowing agent. Additional additives to the process include 1 wt % ABT 1000 talc and a 1% of a chemical blowing agent. The materials were extruded between 20° and 220° C. in the primary extruder and 170-190° C. in the secondary extruder. The output rate of the line was 40 kgs/hr.

### Thermoforming Sheet

Materials were thermoformed on a Hydrotrim Lab thermoformer. The unit has top and bottom heating platens in the oven, a timer to set the hold time in the ovens, vacuum for drawing the material in the molds and plug assist for use with complicated parts. The materials evaluated for this study were made using vacuum only and the top and bottom platens were heated to 260° C.

### Foam Quality

The sample with 20 wt % triacetin had an average cell size of 247 microns, thickness of 3.9 mm and an initial density of 0.105 g/cc. The sample with 15 wt % triacetin had an average cell size of 285 micron, thickness of 4.3 mm, and a initial density of 0.94 g/cc.

### Evaluation

Trays were formed of each material for the weight gain evaluation. Initial weights of the trays were determined and then the trays were filled ¾ with water for specified increments of time. Once the time allocation was reached, the water was removed from the tray, the tray was blotted dry to remove surface moisture and weighed. The change in weight from the initial sample vs. the test sample was recorded. The w % gain was calculated by the following formula:

$$w \% gain = ( ( weight gain of sample - weight gain of initial ) / weight gain of initial )$$

Ideally, the sample will be formed to have good part definition as well as the least amount of moisture gain.

TABLE 7
Impact of Temperature.
Trays: Tray dimensions were 8.61″ long by 6.56″
wide by 1.25″ deep, Draw Ratio was 1.3.

| | | Heating | Sheet | w % | w % | w % | w % | w % | w % |
|---|---|---|---|---|---|---|---|---|---|
| Ex | Triacetin | time | Temp | Gain | Gain | Gain | Gain | gain | Gain |
| # | (wt %) | (sec) | (° C.) | (1 h) | (2 h) | (4 h) | (8 h) | (18 h)* | (24 h) |
| 1 | 20 | 27 | 172.9 | 2.86 | 3.18 | 3.18 | 3.49 | 5.96 | 7.28 |
| 2 | 20 | 35 | 193.8 | 2.50 | 3.13 | 2.81 | 3.75 | 5.56 | 6.56 |
| 3 | 20 | 50 | 196.6 | 2.89 | 3.53 | 3.21 | 4.15 | 7.26 | 9.01 |
| 4 | 20 | 55 | 198.6 | 3.02 | 7.36 | 4.03 | 5.04 | 8.79 | 10.74 |
| 5 | 20 | 60 | 203.1 | 3.28 | 4.74 | 4.76 | 5.84 | 9.07 | 10.93 |
| 6 | 15 | 23 | 174.4 | 3.36 | 4.5 | 3.36 | 7.45 | 10.20 | 12.34 |
| 7 | 15 | 34 | 181.4 | 3.64 | 4.72 | 2.91 | 5.09 | 8.74 | 10.92 |
| 8 | 15 | 52 | 200.3 | 4.92 | 7.2 | 6.05 | 9.09 | 14.25 | 17.43 |

*Calculated, extrapolated from data measured at 1, 2, 4, 8 and 24 h.

The data shows a temperature effect for Ex 1-5 where the ideal temperature for the least water uptake is between 170-200° C. This temperature range is also true for Ex 6-8.,

TABLE 8
Trays - Tray dimensions were 8.62″ long by 6.56″
wide by 1.50″ deep, Draw Ratio was 1.4

| | | Heating | Sheet | w % | w % | w % | w % | w % | w % |
|---|---|---|---|---|---|---|---|---|---|
| Ex | Triacetin | time | Temp | Gain | Gain | Gain | Gain | Gain | Gain |
| # | (wt %) | (sec) | (° C.) | (1 h) | (2 h) | (4 h) | (8 h) | (18 h)** | (24 h) |
| 9* | 20 | 24 | 166.9 | 3.54 | 3.85 | 4.73 | 5.33 | 6.4009 | 7.12 |
| 10 | 20 | 27 | 185.0 | 3.30 | 3.30 | 3.6 | 5.1 | 6.4901 | 7.51 |
| 11 | 20 | 35 | 190.6 | 3.04 | 3.62 | 3.93 | 5.16 | 5.7522 | 6.32 |
| 12 | 20 | 43 | 196.7 | 2.14 | 2.75 | 4.57 | 2.44 | 4.6665 | 5.49 |
| 13 | 20 | 50 | 204.4 | 1.83 | 3.66 | 4.57 | 4.27 | 7.6976 | 9.45 |
| 14* | 15 | 23 | 178.9 | 2.45 | 3.5 | 3.15 | 5.59 | 6.4392 | 7.34 |
| 15 | 15 | 34 | 192.2 | 3.28 | 4.00 | 5.09 | 6.18 | 9.3776 | 11.29 |
| 16 | 15 | 43 | 194.7 | 2.46 | 3.88 | 5.28 | 5.99 | 9.1028 | 10.92 |
| 17 | 15 | 50 | 204.4 | 5.24 | 5.62 | 5.62 | 11.23 | 13.2206 | 15.35 |

*Temperature was too cool, tray did not fully form.
**Calculated, extrapolated from data measured at 1, 2, 4, 8 and 24 h.

The data shows a temperature effect for Ex 9-13 where the ideal temperature for the least water uptake is <200° C. Ex 9 did not fully form at the target temperature. This temperature range is also Ex 14-17 for lowest water uptake was also less <200° C. Ex 14 did not fully form at the target temperature was well.

TABLE 9
Impact of stretch ratio.
Multicavity cups - thick foam

| | | Heating | Sheet | | w % | w % | w % | w % | w % | w % |
|---|---|---|---|---|---|---|---|---|---|---|
| Ex | Triacetin | time | Temp | | Gain | Gain | Gain | Gain | Gain | Gain |
| # | (wt %) | (sec) | (° C.) | ADR | (1 h) | (2 h) | (4 h) | (8 h) | (18 h)* | (24 h) |
| 18 | 20 | 35 | 190.6 | 1.5 | 3.04 | 4.48 | 4.01 | 4.33 | 4.60 | 4.79 |
| 19 | 15 | 34 | 187.8 | 1.5 | 4.47 | 4.88 | 6.33 | 7.60 | 8.53 | 9.35 |
| 20 | 20 | 35 | 190.6 | 2.0 | 3.80 | 3.98 | 4.27 | 4.88 | 5.39 | 5.79 |
| 21 | 15 | 34 | 187.8 | 2.0 | 4.88 | 6.21 | 5.48 | 6.02 | 6.80 | 7.27 |

| | | | | | |
|---|---|---|---|---|---|
| 22 | 20 | 35 | 190.6 | 2.5 | Failed, leaks |
| 23 | 15 | 34 | 187.8 | 2.5 | Failed leaks |

*Calculated, extrapolated from data measured at 1, 2, 4, 8 and 24 h.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A method of forming a foamed article, the method comprising:
(a) producing a foamed sheet from a cellulose ester composition, wherein the cellulose ester composition comprises:
(i) a cellulose acetate, where the cellulose acetate has a degree of substitution for acetyl substituents (“DSAc”) of from 2.2-2.8,
ii) 10 to 25 wt % of a plasticizer, wherein the plasticizer is triacetin, poly (ethylene glycol with a molecular weight of from 200-600, triethyl citrate, or a combination thereof, and
(iii) 0.3 to 8 wt % of a blowing agent,
each based on the total weight of the composition; and
(b) thermoforming the foamed sheet in a mold having a footprint area (X) and a surface area that is less than 1.9X, thereby forming the foamed article,
wherein the thermoforming heats the foamed sheet to a surface temperature of from 170° C. to 205° C.,
wherein when the foamed sheet is formed into a foamed tray and the foamed tray is filled with water and allowed to equilibrate at room temperature for 18 hours, the foam tray has a weight gain of less than 15% according to the Water Absorption Test described in the specification.

2. The method of claim 1, wherein the producing (a) comprises extruding the composition through a die to form an extrudate and processing the extrudate to form the foamed sheet.

3. The method of claim 1, wherein the thermoforming heats the foamed sheet to a surface temperature of from 175° C. to 200° C.

4. The method of claim 1, wherein the plasticizer is present at from 15 to 20 wt %.

5. The method of claim 1, wherein when the foamed article is a foamed tray and the foamed tray is filled with water and allowed to equilibrate at room temperature for 24 hours, less than 10% according to the Water Absorption Test described in the specification.

6. The method of claim 1, wherein the foamed article is a foamed tray.

7. The method of claim 6, wherein the foamed tray is configured to support a food item.

8. The method of claim 7, wherein the food item is an animal or plant protein, a vegetable or a fruit.

9. The method of claim 6, wherein the foamed tray has a width in the range of from 2-14 inches (5.08 cm-35.56 cm) and a length of from 4-24 inches (10.16-60.96 cm).

10. The method of claim 6, wherein the foamed tray has a depth of from 0.5 to 3 inches (1.27 to 7.62 cm).

11. The method of claim 6, wherein the thickness of the foamed tray is from 1 to 10 mm.

12. The method of claim 6, wherein the foamed tray has a density less than 0.20 g/cm³.

13. The method claim 6, wherein the foamed tray is biodegradable.

14. The method of claim 6, wherein the foamed tray is compostable.

15. The method of claim 1, wherein the foamed article is free of corrugations.

16. The method of claim 1, wherein the composition further comprises an additive selected from the group consisting of C20-C40 hydrocarbons (paraffin wax), C12-C16 fatty acids, and mixtures thereof.

17. The method of claim 16, wherein the additive is present at from 1-20 wt %, based on the total weight of the composition.

18. The method of claim 1, wherein the composition further comprises a melt strength enhancer.

19. The method of claim 18, wherein the melt strength enhancer comprises a functional ionic component.
